(19) United States
(12) Patent Application Publication
(10) Pub. No.: US 2007/0191082 A1
(43) Pub. Date: Aug. 16, 2007

(54) DISPLAY FOR SCALE MODEL RACECARS

(76) Inventor: John Robert Stearns, Long Beach, CA (US)

Correspondence Address: KIRKPATRICK & LOCKHART PRESTON GATES ELLIS LLP, 1900 MAIN STREET, SUITE 600, IRVINE, CA, 92614-7319, US

(21) Appl. No.: 11/671,828

(22) Filed: Feb. 6, 2007

Related U.S. Application Data
(60) Provisional application No. 60/773,107, filed on Feb. 13, 2006.

(51) Int. Cl. A63F 13/00

(52) U.S. Cl. 463/6

(57) ABSTRACT

Provided are display devices for scale model race cars and related methods.

### CROSS REFERENCE TO RELATED APPLICATIONS

The present application claims priority under 35 U.S.C. §119(e) to U.S. Provisional Patent Application No. 60/773,107 filed Feb. 13, 2006, which is incorporated by reference herein in its entirety.

### FILED OF THE INVENTION

The present invention relates to display devices for scale model race cars and associated methods.

### BACKGROUND

Avid motor racing fans commonly maintain large collections of scale model race cars. Such model collections are often stored in manners that do not optimize the display value or realism of the car.

A number of means for display are known in the art including shelving units and model stands. Some model stands are known that depict the model in a pseudo-realistic environments such as those depicted at www.racewaydisplays.com or www.showcase-express.com. However, these examples as with others known in the art fail to provide a truly realistic view from all viewing angles.

The purpose of the display is to show the car on a raceway to provide the viewer with a sense of realism. However, the spectator at a raceway, unless privileged enough top be in the pits or infield, actually view the car from behind e the spectator barrier, not from in front. Thus there is a need in the art to provide a means for viewing a model car in a race way environment that better simulates the actual viewing angle the spectator would experience.

### SUMMARY OF THE INVENTION

The present invention provides scale model racecar display devices made to optimize display realism and provide for better organized storage.

In one embodiment of the present invention a model car display device is provided having a scale model raceway with a track section, a retaining wall and a spectator debris barrier wherein the track section is viewable through the debris barrier from an infield perspective and a spectator perspective.

In one embodiment of the present invention the display device simulates a NASCAR motor speedway.

In another embodiment of the present invention the display device simulates a Formula 1 motor speedway.

In another embodiment of the present invention the display device simulates an Indy car raceway.

In another embodiment of the present invention methods for displaying scale model cars are provided.

### BRIEF DESCRIPTION OF THE DRAWINGS

FIG. 1 is a perspective view of a speedway display for model racecars.

FIG. 2 is an infield view of a speedway display for model racecars.

FIG. 3 is a spectator view of a speedway display for model racecars.

FIG. 4 is a profile view of a speedway display for model racecars

### DETAILED DESCRIPTION OF THE INVENTION

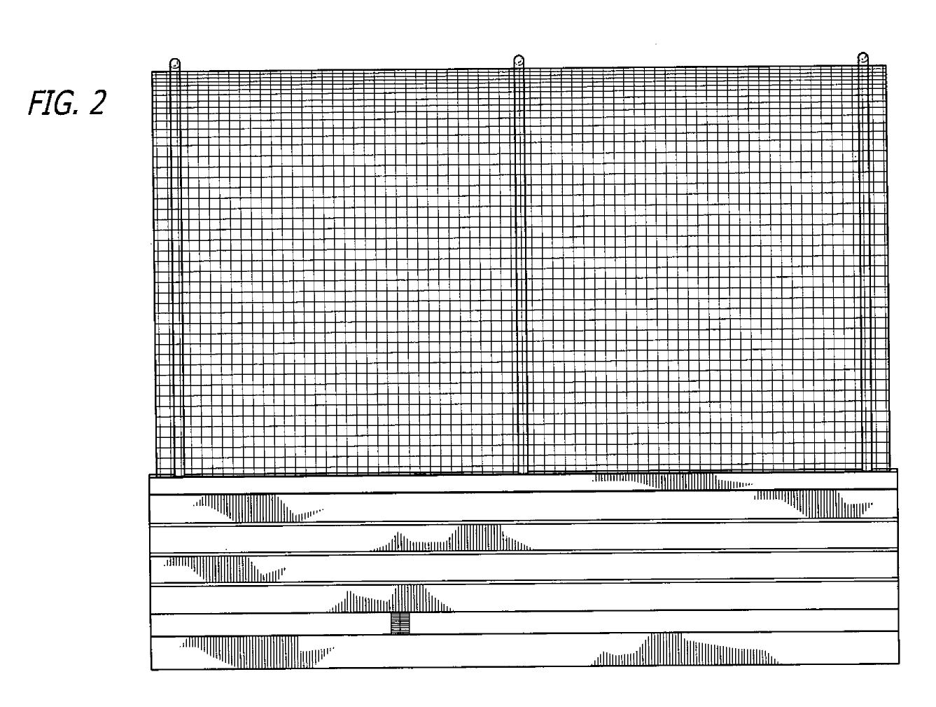

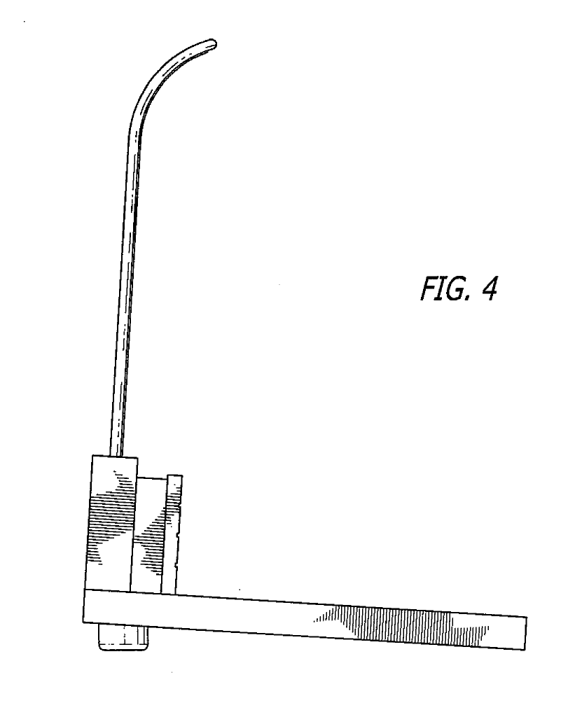

The present invention provides scale model racecar display devices made to optimize display realism and provide for better organized storage. Unlike the prior art, the present invention provides a means for displaying a model racecar that provided for optimum realism in viewing angle. For example, know prior art display means provide the hobbyist infield and profile views of the racecar as depicted in FIG. 2 and FIG. 4. As used herein, “infield view” refers to the perspective of a viewer looking at the passing car unobstructed from inside the race track as opposed to watching the car from the racetrack's outer perimeter (spectator's side) through a debris barrier as is customary for race fans sitting in seats surrounding a race course or track.

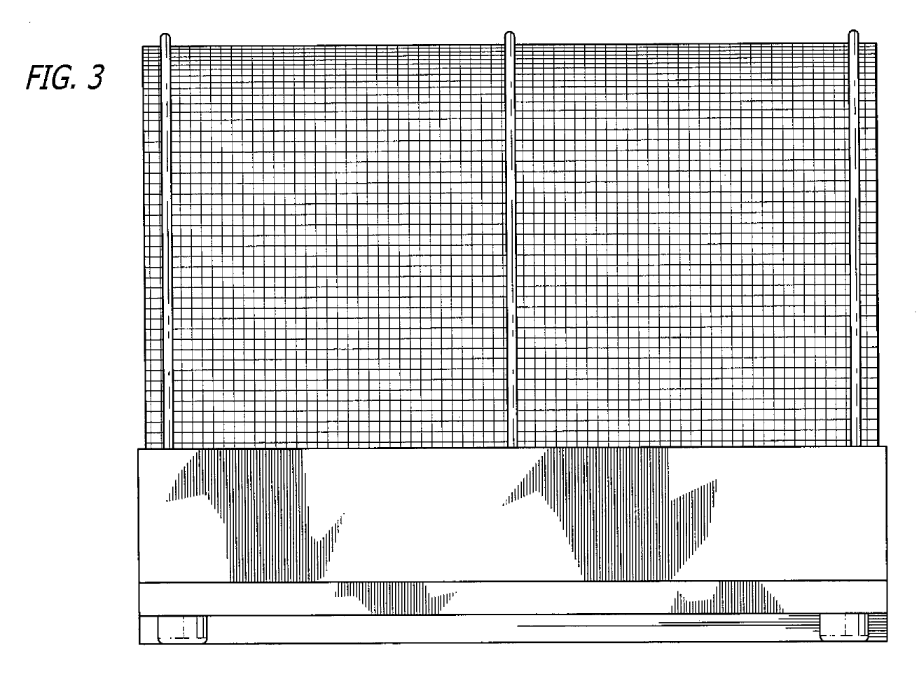

Thus, as can be seen from FIG. 3, the present invention provides a more realistic display means for model race cars by having a wire mesh screen, or debris barrier, similar to those used as raceway spectator barriers on the NASCAR circuit that is permits the hobbyist to view the model car from the same perspective as he would if attending a race and sifting in the spectator seats behind the debris barrier.

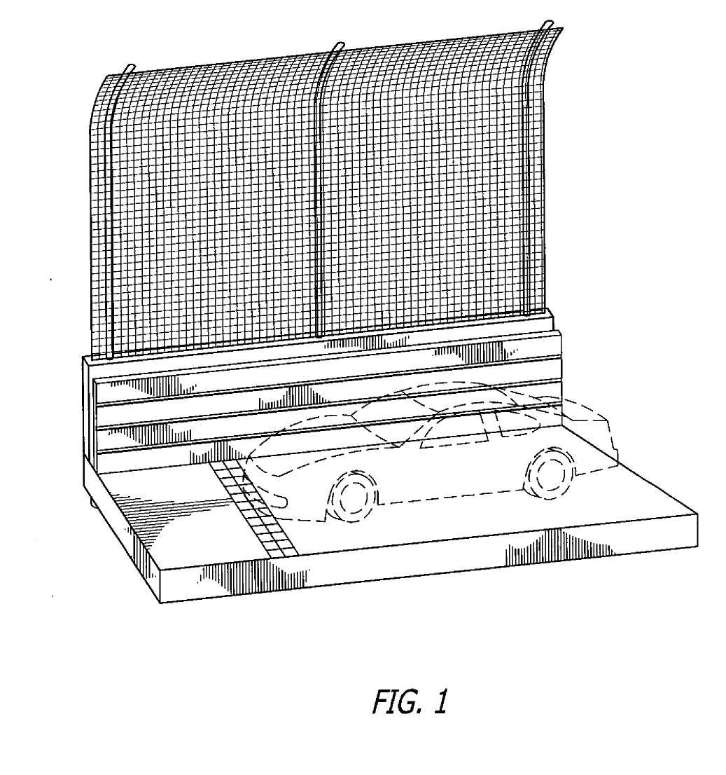

Moreover, the present invention is useful for storing scale model race cars in a manner that simulates race conditions. For example, and not intended as a limitation, a 1/24^{th} scale model NASCAR racecar as depicted in FIG. 1 is placed on the motor speedway display device of the present invention such that it appears crossing the start-finish line. The scale model race car is displayed on the race track against a retaining wall which is further enhanced with a see-through barrier generally used under actual racing condition to prevent cars or debris from injuring spectators.

The see through debris barrier of the present invention is not covered and the display does not further incorporate a solid wall behind the barrier or simulated illustrations of fans viewing the race or the like, that would obscure the hobbyist from viewing the model car from a full 360° angle.

The scale model racecar displays of the present invention can accommodate scale model racecars of most national and international racing circuits. The scale model racecar display provides for a realistic venue to display the scale model racecar by providing crucial details such as but not limited to tire marks on the impact walls, tire marks on the road, color stained impact walls that simulate the marks of a crash into the wall, and realistic fencing above the track complete with wiring and posting.

The spectator debris barrier of the present invention comprises a simulated wire-fence with support posts, regularly or irregularly spaced from each other, emerging from or attached to the impact walls. The support posts are secured to the fencing by other wires, glue, staples, screws, nails, Velcro® or other means. The debris barrier can be made from and narrow gauge drawn or spun material including, but not limited to silk, cotton, polyester, nylon and other polymeric materials, steel, aluminum, copper, nitinol, or other metals and metal alloys (hereinafter referred to as “wire” or “wire screen material”). The intersecting wires may cross at either 90° parallel or perpendicular to the raceway surface, or can be at crossing angles of approximately 45° (plus or minus 20°) relative to the raceway surface. The screen mesh size can be from 1 mm to 20 mm depending on the wire thickness used to create the mesh, on the proviso that the mesh remains substantially transparent from all angles permitting a view of the model care and raceway from the infield and spectator sides (360°). In one embodiment the mesh size is between 2 mm and 5 mm, in another embodiment the mesh size is between 5 mm and 7 mm, in another embodiment the mesh size is between 8 mm and 10 mm. In an alternative embodiment the meshed debris barrier can be molded as an entire unit or alternatively cut from a sold piece of material rather then being constructed from wires. The mesh is generally symmetrical; however it does not necessarily have to be. Alternative embodiments include mesh sizes of alternating size or randomly sized.

In one embodiment of the present invention the racecar display of the present invention comprises a simulated race track (track section) comprising a road-like surface made from any suitable solid material such as, but not limited to wood, plastics, ceramics and metals. The road-like surface may be painted any color and may or may not be textured. In one embodiment the surface is painted black (or formed from a black material) and provided with a textured surface to simulate a race track surface. Alternatively, a brick-like pattern may be incorporated into the surface or the surface may entirely in a brick-like pattern. The road-like surface may optionally have a black and white checkered motif simulating the finish line.

The racecar display of the present invention comprises a simulated retaining wall (that is the solid portion supporting the mesh debris barrier) may be fabricated from any material such as but not limited to wood, plastics, ceramics or metals. The retaining wall may or may not be painted a color different from the color of the material used to fabricate it. The retaining wall can be textured or grooved, it may also be provided with simulated impact injuries such as dents, tears, abrasions, paint marks and tire marks. In one embodiment of the present invention the retaining wall has multiple horizontal grooves and simulates the shock absorbing elements of an actual racetrack adding to the realism of the present invention.

It is understood that the present invention is used to display scale model, not full sized automobiles and must be of a size suitable for use in normal residual dwellings. Thus the racecar model scale can be from between approximately ⅛ scale to 1/100^{th} scale and anywhere in between. A particularly preferred embodiment is a 1/24^{th} scale NASCAR model race car.

Persons having ordinary skill in the arts of carpentry, metal working, plastic modeling, and sculpting possess the necessary skill to make the present invention using the teaching and techniques known to their respective arts. Moreover, persons having ordinary skill in painting and illustration possess the requisite skills to provide the present invention with the distinctive decorative markings discussed in detail above.

The terms “a,” “an,” “the” and similar referents used in the context of describing the invention (especially in the context of the following claims) are to be construed to cover both the singular and the plural, unless otherwise indicated herein or clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A model car display device comprising:
a scale model raceway having a track section, a retaining wall and a spectator debris barrier wherein the track section is viewable through said debris barrier from an infield perspective and a spectator perspective.

2. The display device according to claim 1 wherein said scale model raceway comprises a raceway selected from the group consisting of NASCAR, Formula 1 and Indy cars.

3. The model car display device according to claim 1 where in said scale is from between approximately ⅛ scale to 1/100^{th} scale.

4. The model car display device according to claim 3 wherein said scale is 1/24^{th}.

5. The model car display device according to claim 1 wherein said scale model raceway comprises accommodations for scale model racecars of national and international racing circuits.
